(19) United States
(12) Patent Application Publication
(10) Pub. No.: US 2026/0220532 A1
(43) Pub. Date: Jul. 30, 2026

(54) TEXT GENERATION LEARNING APPARATUS, TEXT GENERATION APPARATUS, TEXT GENERATION LEARNING METHOD AND PROGRAM

(71) Applicant: NTT, Inc., Tokyo (JP)

(72) Inventors: Ryota TANAKA, Tokyo (JP); Kyosuke NISHIDA, Tokyo (JP); Kuniko SAITO, Tokyo (JP)

(73) Assignee: NTT, Inc, Tokyo (JP)

(21) Appl. No.: 19/141,969

(22) PCT Filed: Dec. 22, 2022
(86) PCT No.: PCT/JP2022/047446

§ 371 Date: Jun. 20, 2025

(51) Int. Cl. G06N 20/00; G06F 16/3329

(52) U.S. Cl. CPC G06N 20/00; G06F 16/33295

(57) ABSTRACT

A text generation training apparatus includes: a learning unit configured to train a model, receiving, as input, information included in each of a plurality of document images, constraint information related to generation of a sentence based on the information, and a page number of each of the plurality of document images, based on an estimation result of an output sequence output from the model and a correct output sequence for the input, and thus can generate a sentence based on the plurality of document images.

### TECHNICAL FIELD

The present invention relates to a text generation training apparatus, a text generation apparatus, a text generation training method, and a program.

### BACKGROUND ART

There are question answering technologies that take question text and a document image including text as input and generate answer text to the question on the basis of the content of the image (for example, Non-Patent Literature 1 and 2). In these conventional technologies, learning data is a set of three items {document image, question sentence, and answer sentence}, and first, text and document areas (title, paragraph, caption, and the like) are extracted from the document image to acquire the text and coordinates of the document areas/visual information (visually recognizable information) in the document image. Then, learning is performed to generate an answer with input of the acquired information and the given question sentence.

### CITATION LIST

### Non-Patent Literature

Non-Patent Literature 1: Powalski Rafal', Borchmann L'ukasz (l′ indicates a kreska on l, and L′ indicates a kreska on L.), Jurkiewicz Dawid, Dwojak Tomasz, Pietruszka Michal', Pal'ka Gabriela: Going Full-TILT Boogie on Document Understanding with Text-Image-Layout Transformer. ICDAR21 Non-Patent Literature 2: Ryota Tanaka, Kyosuke Nishida, Sen Yoshida: VisualMRC: Machine Reading Comprehension on Document Images. AAAI21

### SUMMARY OF INVENTION

### Technical Problem

For example, consider the question “What was the mobile business share of N company's mobile company in 2013?”. In addition, assume that there are a document image corresponding to a page A necessary for understanding that “N company's mobile company” is “ND company” and a document image corresponding to a page B different from the page A, in which “mobile business shares of various companies in 2013” are described. In this example, even in a case where any one of the pages (document images) is referred to, it is difficult to understand the question sentence (that is, derive an answer sentence to the question sentence), and it is necessary to consider relationships between the pages (between the document images). However, in the conventional technologies, it is assumed that one document image is input, and input of a plurality of document images is not considered.

The present invention has been made in view of the above points, and an object of the present invention is to enable generation of a sentence based on a plurality of document images.

### Solution to Problem

Therefore, in order to solve the above problem, a text generation training apparatus includes: a learning unit configured to train a model, receiving, as input, information included in each of a plurality of document images, constraint information related to generation of a sentence based on the information, and a page number of each of the plurality of document images, based on an estimation result of an output sequence output from the model and a correct output sequence for the input.

### Advantageous Effects of Invention

It is possible to generate a sentence based on a plurality of document images.

### BRIEF DESCRIPTION OF DRAWINGS

FIG. 1 is a diagram illustrating a hardware configuration example of a text generation apparatus 10 according to an embodiment of the present invention.

FIG. 2 is a diagram illustrating a functional configuration example of the text generation apparatus 10 (text generation training apparatus) during training according to the embodiment of the present invention.

FIG. 3 is a diagram illustrating an example of a document image set, a question sentence, and a correct sentence.

FIG. 4 is a flowchart for describing an example of a processing procedure executed by the text generation apparatus 10 during training.

FIG. 5 is a diagram for describing a sentence generation model ml during training.

FIG. 6 is a diagram illustrating a functional configuration example of the text generation apparatus 10 during inference according to the embodiment of the present invention.

FIG. 7 is a flowchart for describing an example of a processing procedure executed by the text generation apparatus 10 during inference.

FIG. 8 is a diagram for describing a sentence generation model ml during inference.

### DESCRIPTION OF EMBODIMENTS

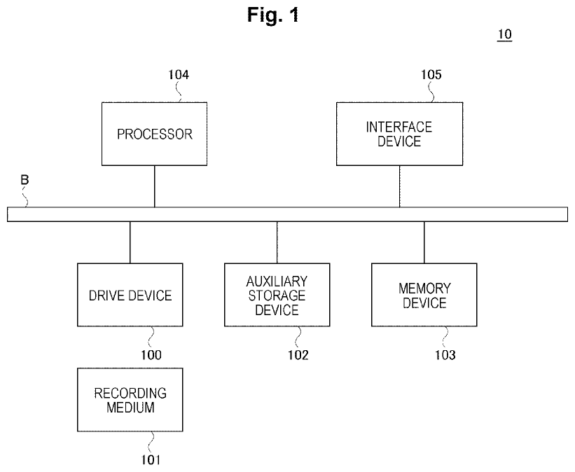

Hereinafter, embodiments of the present invention will be described with reference to the drawings. FIG. 1 is a diagram illustrating a hardware configuration example of a text generation apparatus 10 according to an embodiment of the present invention. The text generation apparatus 10 in FIG. 1 includes a drive device 100, an auxiliary storage device 102, a memory device 103, a processor 104, an interface device 105, and the like that are connected to each other via a bus B.

A program for realizing processing in the text generation apparatus 10 is provided by a recording medium 101 such as a CD-ROM. When the recording medium 101 storing the program is set in the drive device 100, the program is installed in the auxiliary storage device 102 from the recording medium 101 via the drive device 100. However, the program is not necessarily installed from the recording medium 101, and may be downloaded from another computer via a network. The auxiliary storage device 102 stores the installed program and also stores necessary files, data, and the like.

In a case where an instruction to start the program is given, the memory device 103 reads the program from the auxiliary storage device 102 and stores the program. The processor 104 is a CPU or a graphics processing unit (GPU), or a CPU and a GPU, and executes a function related to the text generation apparatus 10 according to the program stored in the memory device 103. The interface device 105 is used as an interface for connection to a network.

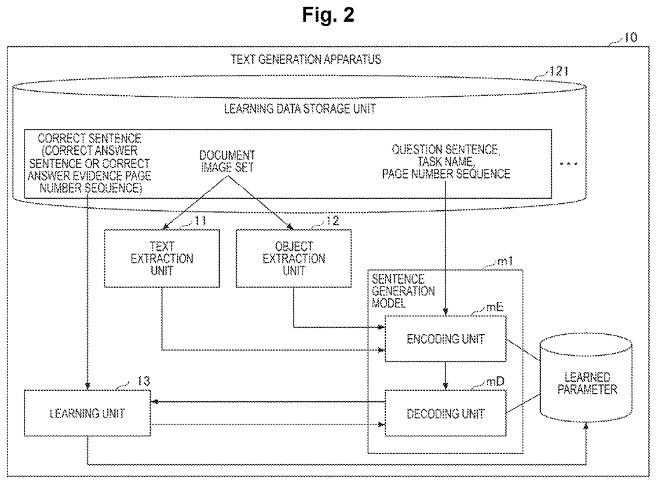

FIG. 2 is a diagram illustrating a functional configuration example of the text generation apparatus 10 (text generation training apparatus) during training according to the embodiment of the present invention. In FIG. 2, the text generation apparatus 10 includes a text extraction unit 11, an object extraction unit 12, a learning unit 13, a sentence generation model ml, and the like. The units and the sentence generation model ml are realized by processing executed by the processor 104 using one or more programs installed in the text generation apparatus 10. The text generation apparatus 10 also uses a learning data storage unit 121. The learning data storage unit 121 can be realized using, for example, the auxiliary storage device 102 or a storage device connectable to the text generation apparatus 10 via a network.

The learning data storage unit 121 stores a plurality of pieces of learning data for training the sentence generation model ml. One piece of learning data is a set of a question sentence, a document image set, a correct sentence (answer sentence or correct answer evidence page number sequence), a task name, and a page number sequence. The question sentence is a string (text) indicating a question. The document image set is a set of a plurality of document images. The document image is an image including text and a graphic or image of an object.

The correct sentence is a string indicating a correct answer to the question sentence, and the content of the string is a correct answer sentence or a correct answer evidence page number sequence according to the task. The correct answer sentence is a sentence indicating an answer to the question sentence. The correct answer evidence page number sequence is a sequence of identification numbers of one or more pages (document images) that provide the evidence of the correct answer sentence in the document image set. The task name is information (type information) indicating the task type. In the present embodiment, the task name is “Question Answering” or “Evidence Selection”. The “Question Answering” is a task name of a question answering task, and the “Evidence Selection” is a task name of an answer evidence selection task. However, other task names may be used. The question answering task is a task of generating an answer sentence. The answer evidence selection task is a task of selecting (or determining) an answer evidence page number sequence. The page number sequence is a sequence of page numbers of the document images constituting the document image set.

For example, N sets (learning data) of question sentences, document image sets, correct sentences (correct answer sentences or correct answer evidence page number sequences), task names, and page number sequences are prepared, and two pieces of learning data having different task names are prepared for each set. That is, 2×N pieces of learning data are prepared. The correct sentence of learning data with a task name “Question Answering” is a correct answer sentence, and the correct sentence of learning data with a task name “Evidence Selection” is a correct answer evidence page number sequence.

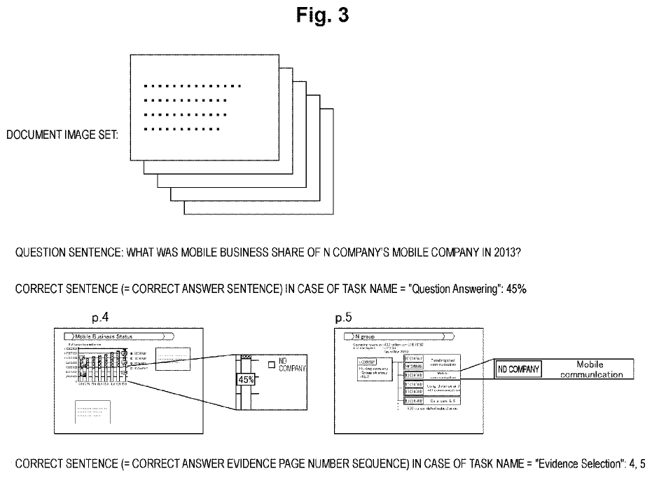

FIG. 3 is a diagram illustrating an example of a document image set, a question sentence, and a correct sentence. FIG. 3 illustrates an example of a correct sentence (=correct answer sentence) in a case where the task name is “Question Answering” and a correct sentence (correct answer evidence page number sequence) in a case where the task name is “Evidence Selection” when the question sentence is “What was the mobile business share of N company's mobile company in 2013?”. In the example of FIG. 3, since “45%” that is the correct answer sentence is generated from the information included in the document images of P4 and P5, the correct answer evidence page sequence is “4, 5”.

For each document image included in the document image set, the text extraction unit 11 detects an area including a word sequence in the document image, recognizes (extracts) a word in the detected area, and outputs in-document image text information. The in-document image text information is information including a document text area feature v^{ocr}, a document text sequence, a rectangular document text area for each unit of text, and the like.

The rectangular document text area consists of the upper-left and lower-right coordinates of the rectangular area for each word recognized by character recognition on the document image.

The document text sequence is a sequence of words (extracted from the document image) recognized in the document image. The document text sequence is a sequence of words in which the text is sorted in the order of left-to-right and top-to-bottom according to the coordinates of the rectangular document text area in which each word is recognized in the document image. As a method of acquiring the document text sequence and the rectangular document text area, any method may be adopted as long as it is a method in which it is possible to output the word sequence and the rectangular area of the words from the document image. For example, the Google (registered trademark) Vision API in Reference Literature 1 may be used.

Literature information of each piece of reference literature will be described later.

The document text area feature v^{ocr} is a sequence of vectors for each rectangular document text area. One vector represents a feature of a word in one rectangular document text area with 2,048 dimensions. Accordingly, the document text area feature v^{ocr} is a vector sequence of 2,048×the number of rectangular document text areas. Any method may be used to acquire the document text area feature v^{ocr}. For example, the Faster-RCNN described in Reference Literature 2 may be used.

The object extraction unit 12 detects, for each document image included in the document image set, an object included in the document image, and outputs information related to the object (referred to as “in-document image object information” below). The in-document image object information is information including an object area feature v^{obj} for each object, an object area semantic label for each object, a rectangular object area for each object, and the like.

The rectangular object area consists of the upper-left and lower-right coordinates of the area including an object recognized by object detection on the document image. For example, as the object, a title or a figure such as a table in the document image is detected. The title includes one or more words. Therefore, both the in-document image text information and the in-document image object information are extracted from the title. That is, both the in-document image text information and the in-document image object information may be extracted with respect to the same part in the document image.

The object area feature v^{obj} is a sequence of vectors for each rectangular object area. One vector represents a feature in one rectangular object area with 2,048 dimensions. Accordingly, the object area feature v^{obj} is a vector sequence of 2,048×the number of rectangular object areas.

The object area semantic label includes nine kinds of semantic labels (such as “Title” and “Table”) representing the meaning (name) of the content (that is, the object) of the rectangular object area. “Title” is a semantic label of a title, and “Table” is a semantic label of a table.

Processing for acquiring the in-document image object information is not limited to predetermined processing as long as the object area feature v^{obj}, the object area semantic label, and the rectangular object area can be acquired from the document image. For example, the Faster-RCNN in Reference Literature 2 may be used.

The learning unit 13 controls learning of the sentence generation model ml. The sentence generation model includes an encoding unit mE as an encoder and a decoding unit mD as a decoder. Details of the sentence generation model ml will be described later.

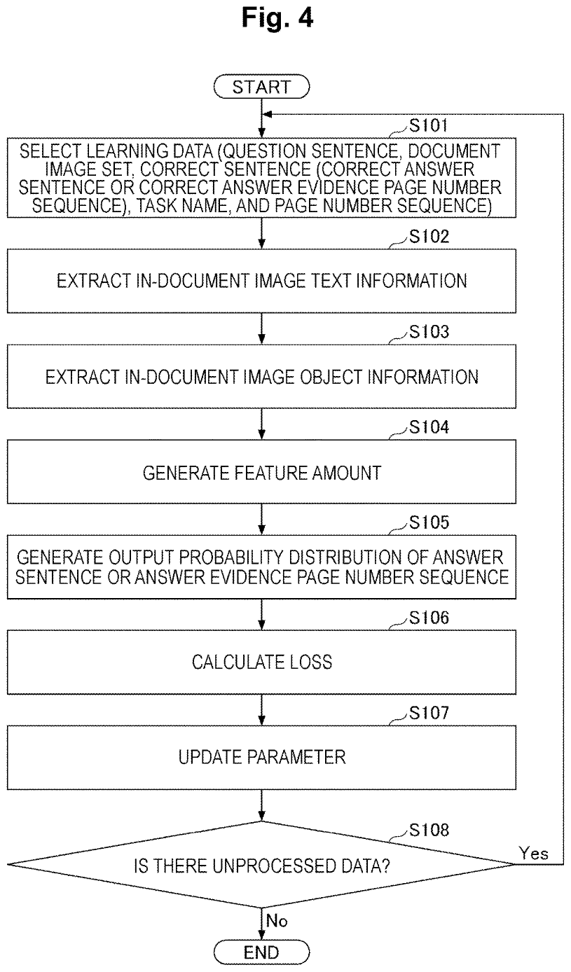

FIG. 4 is a flowchart for describing an example of a processing procedure executed by the text generation apparatus 10 during training.

In Step S101, the learning unit 13 selects, as a processing target, one piece of unprocessed learning data (referred to as “target learning data” below) from a learning data group stored in the learning data storage unit 121.

Next, for each document image included in a document image set of the target learning data, the text extraction unit 11 detects an area including text in the document image, recognizes the text in the detected area, and outputs in-document image text information (S102).

Next, the object extraction unit 12 detects, for each document image included in the document image set of the target learning data, an object included in the document image, and outputs in-document image object information for each object (S103).

Next, when the learning unit 13 inputs, into the encoding unit mE of the sentence generation model ml, the in-document image text information of each document image extracted in Step S102, the in-document image object information of each document image extracted in Step S103, and the question sentence, task name, and page number sequence that is a sequence of page numbers of pages of the document image set (that is, page numbers of the document images) of the target learning data, the encoding unit mE generates an encoded feature amount (S104).

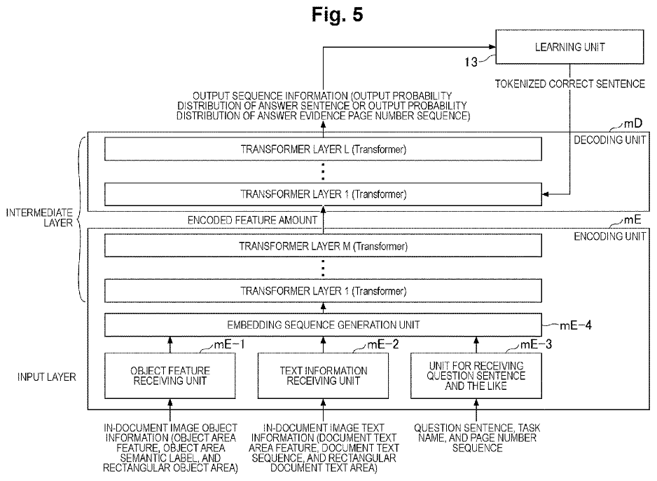

FIG. 5 is a diagram for describing the sentence generation model ml during training. As illustrated in FIG. 5, the encoding unit mE includes an object feature receiving unit mE-1, a text information receiving unit mE-2, a unit mE-3 for receiving a question sentence and the like, an embedding sequence generation unit mE-4, and M transformer layers (transformers). The object feature receiving unit mE-1 receives input of the in-document image object information (object area feature v^{obj}, object area semantic label, and rectangular object area) of each document image included in the document image set of the target learning data. The text information receiving unit mE-2 receives input of the in-document image text information (document text area feature v^{ocr}, document text sequence, and rectangular document text area) of each document image. The unit mE-3 for receiving a question sentence and the like receives the page number sequence of the target learning data, the question sentence of the target learning data, and the task names.

The encoding unit mE executes the following Steps 1 to 4 in response to the reception of the input.

(Step 1) The text information receiving unit mE-2 divides each received document text sequence into a sequence w^{ocr} of tokens that are predetermined processing units. The unit mE-3 for receiving a question sentence and the like divides the received question sentence into a sequence w^{q} of tokens that are predetermined processing units. The object feature receiving unit mE-1 divides each received object area semantic label into a sequence w^{obj} of tokens that are predetermined processing units. As an example of the division processing into predetermined processing units (tokens), the byte-level BPE shown in Reference Literature 3 may be used. Note that (Step 1) may be performed in advance outside the encoding unit mE, for example, in the text extraction unit 11 or the object extraction unit 12. A token sequence (referred to as “document image token sequence” below) c^{k} generated in association with the k-th document image is defined as follows.

$${c}^{k} = ( w\_ {1}^{obj} , w\_ {1}^{ocr} , w\_ {2}^{obj} , w\_ {2}^{ocr} , … , {w\_n}^{obj} , {w\_n}^{ocr} )$$

In the following description, attention is focused on the k-th document image, but similar processing is executed for each document image.

### (Step 2)

The embedding sequence generation unit mE-4 prepares (generates) an input token sequence of the k-th document image as follows by using: a task name t∈{Question Answering, Evidence Selection) of the target learning data; the token sequence w^{q} of the question sentence of the target learning data; a page number p^{k} of the k-th document image in the page number sequence of the target learning data; and the document image token sequence c^{k} of the k-th document image.

$${x}^{k} = ( task : name question : {w}^{q} page : {p}^{k} context : {c}^{k} )$$

Here, “task:”, “question:”, “page:”, and “context:” are token sequences imparted to the heads of the task name, the token sequence w_{q} of the question sentence, the page number p^{k}, and the document image token sequence c^{k} in order, and may be substituted with other strings as long as the strings are token sequences expressing them. In addition, the page number page:p^{k} can also be included in c^{k}. In the present embodiment, x^{k} is defined as a token sequence with a sequence length U=1,024.

(Step 3) The embedding sequence generation unit mE-4 generates an input embedding sequence in the k-th document image as follows.

$${e}^{k} = LayerNorm ( {e}_{token}^{k} + {e}_{seg}^{k} + {e}_{vis}^{k} + {e}_{loc}^{k} )$$

Here, LayerNorm is, for example, the normalization method shown in Reference Literature 4. In addition, each input embedding sequence is a D×L-dimensional vector. In the present embodiment, D=512 and L=200.

eₜₒₖₑₙ^{k} is the transformation embedding the input token sequence x^{k} into a corresponding D-dimensional vector. In the present embodiment, an embedding vector (D=512) learned according to Reference Literature 5 is set as an initial value and is set as a learning parameter. A parameter of another encoder-decoder pre-learned language model may be used.

e_{seg}^{k} is the D-dimensional vector embedding corresponding to the segment (information indicating the object area to which the token in each page belongs) in the input token sequence x^{k}.

eᵥᵢₛ^{k} is the processing involving conversion into the D-dimensional vector connecting the document text area feature v^{ocr} and the object area feature v^{obj}.

e_{loc}^{k} is the D-dimensional embedding representing the rectangular document text area and the rectangular object area of the k-th document image. For example, the method used in Non-Patent Literature 2 may be used.

In order to calculate e^{k}, the sequence length of each vector that is a target of linear combination is required to be aligned to match the D-dimension.

Therefore, regarding eᵥᵢₛ^{k} and e_{loc}^{k}, parts corresponding to “task name, question sentence, and page number” with no rectangular area are set as D-dimensional zero vectors.

(Step 4) The embedding sequence generation unit mE-4 inputs the input embedding sequence e^{k} in each document image to the M transformer layers based on Reference Literature 6. The M transformer layers generate e^{k}′ for one e^{k}, performs vector concatenation, and outputs an encoded feature amount E=[e¹′, . . . , e^{K}′]. Here, K represents the number of document images (the number of pages).

In the present embodiment, K=20, and the pre-learned 6-transformer layer shown in Reference Literature 6 is used. Therefore, in the present embodiment, M=6. A parameter of another pre-learned language model may be used.

As described above, in Step S104 in FIG. 4, the encoded feature amount E=[e¹, . . . , e^{K}′] is output from the encoding unit mE.

Next, the decoding unit mD of the sentence generation model ml generates output sequence information (output probability distribution of the answer sentence or answer evidence page number sequence), that is an estimation result of the output sequence, on the basis of the encoded feature amount E and the tokenized correct sentence (correct answer sentence or correct answer evidence page number sequence) of the target learning data input from the learning unit 13 (S105). That is, the learning unit 13 performs tokenization processing on the correct sentence (correct answer sentence or correct answer evidence page number sequence) of the target learning data. The learning unit 13 may receive, as input, a tokenized correct sentence. For example, the byte-level BPE shown in Reference Document 3 may be used as the tokenization processing.

Specifically, the decoding unit mD executes the following Steps 11 to 13.

(Step 11) The decoding unit mD inputs the (t−1)-th token in the token sequence of the correct sentence (correct answer sentence or correct answer evidence page number sequence) input by the learning unit 13 in each output step t, and generates the t-th token. Then, the decoding unit mD generates an output sequence in the output step t by combining the tokens that have been output so far. That is, during training, the output sequence in the output step t is a token sequence from the head of the token sequence of the correct sentence to the t-th token. However, in the present embodiment, in a case where the number of the answer evidence page numbers is one or more, the page numbers are connected using “,”. The output step is a step in which one token is output from the decoding unit mD. The learning unit 13 imparts, to the head of the token sequence of the correct sentence input to the decoding unit mD, “<s> Question Answering:” or “<s> Evidence Selection:” as a start symbol, and imparts the symbol </s> as a terminal symbol to the end of the token sequence. That is, “<s> [task name]” is imparted as a start symbol.

The byte-level BPE shown in Reference Document 3 can be used as an example of the tokenization processing for the output sequence.

### (Step 12)

The encoding unit mE inputs the encoded feature amount and the output sequence in the output step t to the L-transformer layer (transformer). As a result, a representation hₜ of the output token in the output step t is output from the L-transformer layer. In the present embodiment, the pre-learned transformer shown in Reference Literature 5 is used. Similarly, a parameter of another pre-learned language model may be used.

### (Step 13)

The decoding unit mD obtains a probability distribution p(yₜ|y_{<t}) of the t-th token through the linear transformation and softmax function on the basis of the representation hₜ of the output token. t satisfies 0≤t≤T. T is an upper limit of the length of the output token sequence, and in the present embodiment, T=60.

When (Steps 11 to 13) are repeated up to T times, the encoding unit mE outputs output sequence information that is a sequence of the probability distributions p based on representations H=[h_1, . . . , h_T] of the output tokens.

Next, the learning unit 13 calculates a loss as shown below on the basis of the output sequence information (estimation result of the output sequence) and the correct sentence (S106).

$$L = - \frac{1}{T} {\sum }_{t} ln ( p ( {y}_{t}^{*} \vert {y}_{< t} ) ) \qquad [ Math . 1 ]$$

Here, yₜ* is a token of the correct sentence in the output text.

Next, the learning unit 13 updates the model parameters of the sentence generation model ml (encoding unit mE and decoding unit mD) to minimize the loss (S107).

When Steps S101 to S107 are executed for all pieces of learning data stored in the learning data storage unit 121 (No in S108), the processing procedure in FIG. 4 ends.

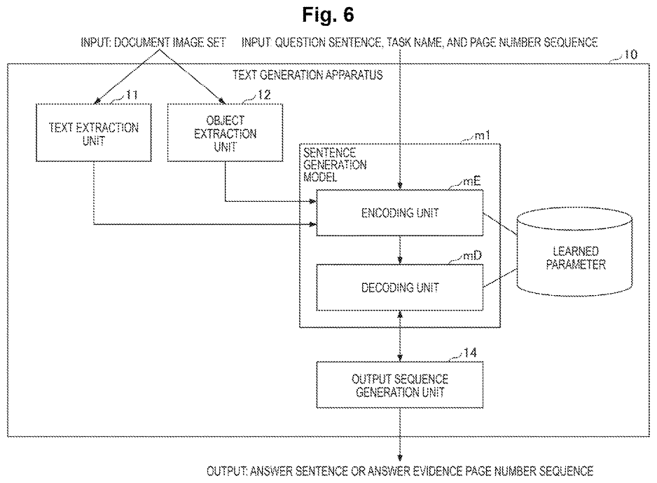

Next, inference will be described. FIG. 6 is a diagram illustrating a functional configuration example of the text generation apparatus 10 during inference according to the embodiment of the present invention. In FIG. 6, the same parts as those in FIG. 2 are denoted by the same reference numerals, and the description thereof will be omitted as appropriate.

During inference, the text generation apparatus 10 includes an output sequence generation unit 14. The output sequence generation unit 14 is realized by processing executed by the processor 104 using one or more programs installed in the text generation apparatus 10.

The output sequence generation unit 14 generates an answer sentence or an answer evidence page number sequence on the basis of the output sequence information output from the sentence generation model ml for a question sentence or the like input into the sentence generation model ml during inference.

During inference, the text generation apparatus 10 need not include the learning unit 13 and the learning data storage unit 121. Furthermore, the text generation apparatus 10 during inference and the text generation apparatus 10 during training may be realized using different computers.

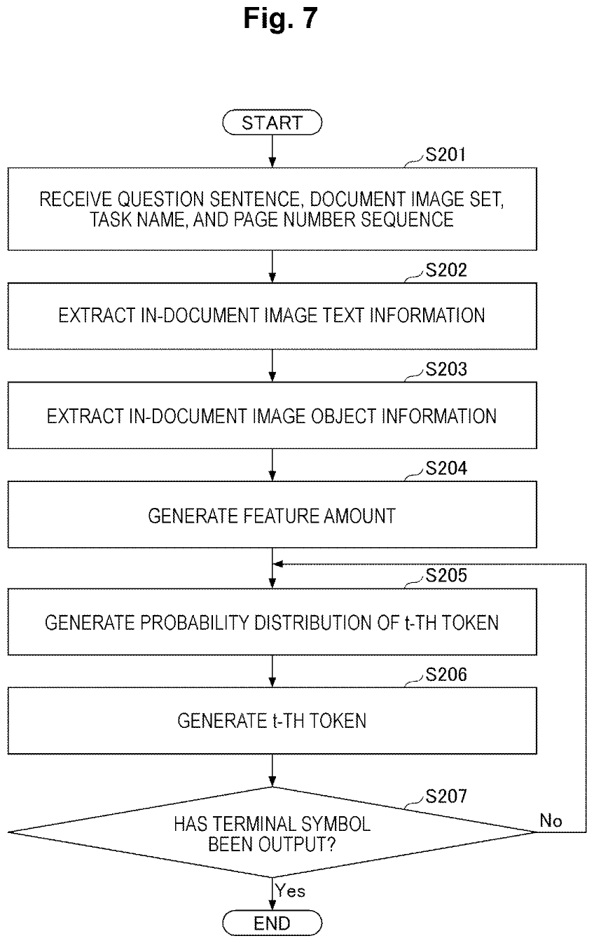

FIG. 7 is a flowchart for describing an example of a processing procedure executed by the text generation apparatus 10 during inference.

In Step S201, the text generation apparatus 10 receives input of input data. The input data includes a document image set, a question sentence, a task name, a sequence of page numbers of document images constituting the document image set, and the like.

Next, for each document image included in the document image set of the input data, the text extraction unit 11 detects a text area included in the document image, recognizes (extracts) the text in the detected area, and outputs in-document image text information (S202).

Next, the object extraction unit 12 extracts, for each document image included in the document image set of the input data, object information included in the document image, and outputs in-document image object information (S203)

Next, the encoding unit mE of the sentence generation model ml inputs the in-document image text information of each document image extracted in Step S202, the in-document image object information of each document image extracted in Step S203, and the question sentence, task name, and page number sequence of the input data, and generates an encoded feature amount E (S204).

Steps S202 to S204 have the same processing content as Steps S102 to S104 in FIG. 4, except that the data to be processed is different. Subsequent Steps S205 to S207 are executed in each output step.

In Step S205, the encoding unit mE executes processing similar to (Step 11) to (Step 13), described in association with training, once to generate a probability distribution p(yₜ|y_{<t}) of the t-th token.

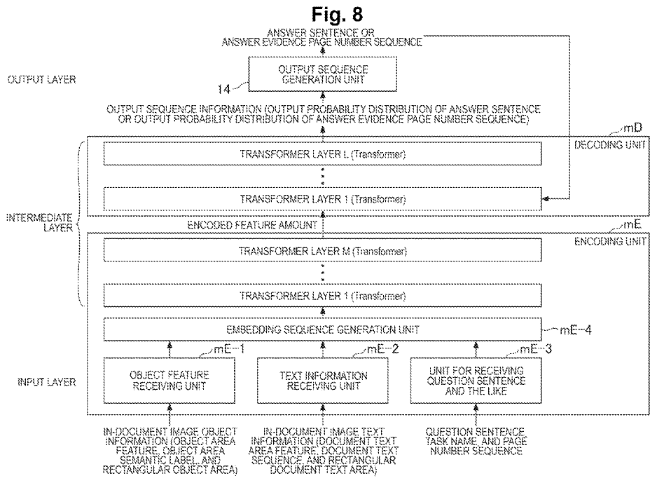

However, a part of (Step 11) during inference is different from that during training. Specifically, as illustrated in FIG. 8, during inference, a token output from the output sequence generation unit 14 in each output step is input into the decoding unit mD, and a combination of the tokens is set as an output sequence in the output step t. That is, the output sequence in the output step t during inference is an answer sentence or an answer evidence page sequence generated by the output sequence generation unit 14 until t. The output sequence generation unit 14 imparts “<s> Question Answering:” or “<s> Evidence Selection:” as a start symbol to the head of the first token.

Next, the output sequence generation unit 14 generates the t-th token yₜ (a part of the answer sentence or page number sequence) by selecting the token with the highest probability distribution on the basis of the probability distribution p(yₜ|y_{<t}) of the t-th token or sampling the token according to the probability distribution, and outputs the token yₜ (S206)

If the token yₜ is not a terminal symbol </s> (No in S207), Step S205 and the subsequent steps are repeated. If the token yₜ is the terminal symbol </s> (Yes in S207), the processing procedure in FIG. 7 ends. The sequence of yₜ's output so far is the answer sentence or the answer evidence page sequence for the question sentence.

As described above, according to the present embodiment, the sentence generation model ml has a model structure into which a document image set can be input. Accordingly, it is possible to generate a sentence based on a plurality of document images. As a result, for example, it is possible to capture relationships between document images, and thus it is possible to understand many visually expressed documents (presentation slides, papers, PDF documents, HTML documents, and the like) existing in the real world as knowledge sources and generate sentences (question answering).

In a case where, in the given document image set, both document images that are suitable for answer generation and document images that are not suitable for answer generation are included, the document images that are not suitable for answer generation may become noise, making it difficult to output a correct answer in some cases. Determining whether each document image is suitable for answer generation (that is, which page is necessary for answer generation) is closely related to generation of an answer sentence, but in the conventional technologies, it is difficult to simultaneously learn a task of selecting or determining a page necessary for answer generation and a task of generating an answer.

According to the present embodiment, in addition to the question answering task, the task of selecting or determining a page number serving as answer evidence is learned simultaneously (in a single model) in a unified format (a format (framework) in which an answer sentence or an answer evidence page number is generated as a token sequence with input to the encoding unit mE in the form of “task name:” such as “Question Answering:” or “Evidence Selection:”). As a result, it is possible to specify a document image (page) required for an answer according to the question sentence and generate an answer sentence with higher accuracy than in the conventional technologies.

An example has been described in which the constraint information related to generation of a sentence based on the document image set is a question sentence, and the output sequence (answer sentence or answer evidence page sequence) according to the question sentence is generated. However, the present embodiment may be applied to a task in which, with input of another constraint information, an output sequence according to the other constraint information is generated.

For example, the present embodiment may be applied to a task of generating a summary sentence or a caption (headline, title, or the like) regarding information extracted from the document image set. For the task, a query (a string indicating a focus or an attention point) may be used as constraint information related to generation of a sentence.

Query-specified summarization can be realized by preparing a set of three items {document image set, query, and summary sentence} as learning data. In addition, extractive/generative summarization requiring no query can be realized by preparing a set of two items {document image set and summary sentence}.

The text generation apparatus 10 according to the present embodiment provides a specific improvement in conventional methods as described in Non-Patent Literatures 1 and 2, and shows an advancement in various technical fields in which natural language sentence generation technologies are used.

Literature information of the reference literatures cited in the present exemplary embodiment will be described below.
[Reference Literature 1] Google Vision API. https://cloud.google.com/vision
[Reference Literature 2] Shaoqing Ren, Kaiming He, Ross B. Girshick, Jian Sun: Faster R-CNN: Towards Real-Time Object Detection with Region Proposal Networks. NIPS 2015: 91-99
[Reference Literature 3] Alec Radford, Jeffrey Wu, Rewon Child, David Luan, Dario Amodei, and Ilya Sutskever: Language models are unsupervised multitask learners. Technical report, OpenAI, 2019
[Reference Literature 4] Jimmy Lei Ba, Jamie Ryan Kiros, Geoffrey E. Hinton: Layer Normalization. Arxiv, 2016
[Reference Literature 5] Colin Raffel, Noam Shazeer, Adam Roberts, Katherine Lee, Sharan Narang, Michael Matena, Yanqi Zhou, Wei Li, Peter J. Liu. Exploring the Limits of Transfer Learning with a Unified Text-to-Text Transformer. JMLR
[Reference Literature 6] Gautier Izacard and Edouard Grave: Leveraging Passage Retrieval with Generative Models for Open Domain Question Answering. EACL2021

With regard to the above embodiments, the following clauses are further disclosed.

### Clause 1

A text generation training apparatus including:
a memory; and
at least one processor connected to the memory,
in which the processor trains a model, receiving, as input, information included in each of a plurality of document images, constraint information related to generation of a sentence based on the information, and a page number of each of the plurality of document images, based on an estimation result of an output sequence output from the model and a correct output sequence for the input.

### Clause 2

A text generation apparatus including:
a memory; and
at least one processor connected to the memory,
in which the processor generates, based on output from a model in a case where the model, that receives, as input, first information extracted from each of a plurality of first document images, first constraint information related to generation of a sentence based on the first information, and a page number of each of the plurality of first document images and that is trained based on an estimation result of an output sequence output from the model and a correct output sequence for the input, receives as input second information extracted from each of a plurality of second document images, second constraint information related to generation of a sentence based on the second information, and a page number of each of the plurality of second document images, an output sequence according to the plurality of second document images and the second constraint information.

### Clause 3

A recording medium recording a program that causes a computer to execute
processing of training a model, receiving, as input, information included in each of a plurality of document images, constraint information related to generation of a sentence based on the information, and a page number of each of the plurality of document images, based on an estimation result of an output sequence output from the model and a correct output sequence for the input.

Although the embodiments of the present invention have been described in detail above, the present invention is not limited to such specific embodiments, and various modifications and changes can be made within the scope of the gist of the present invention described in the claims.

### REFERENCE SIGNS LIST

10 Text generation apparatus
11 Text extraction unit
12 Object extraction unit
13 Learning unit
14 Output sequence generation unit
100 Drive device
101 Recording medium
102 Auxiliary storage device
103 Memory device
104 Processor
105 Interface device
121 Learning data storage unit
B Bus
ml Sentence generation model
mE Encoding unit
mE-1 Object feature receiving unit
mE-2 Text information receiving unit
mE-3 Unit for receiving question sentence and the like
mE-4 Embedding sequence generation unit
mD Decoding unit

1. A text generation training apparatus comprising:
a processor; and
a memory storing program instructions that cause the processor to train a model, receiving, as input, information included in each of a plurality of document images, constraint information related to generation of a sentence based on the information, and a page number of each of the plurality of document images, based on an estimation result of an output sequence output from the model and a correct output sequence for the input.

2. The text generation training apparatus according to claim 1, wherein
task type information is further input into the model, and
the program instructions cause the processor to
train the model based on an estimation result of a sentence according to the constraint information, output from the model, and a correct sentence for the input in a case where the task type information input into the model indicates a task related to generation of a sentence, and
train the model based on a sequence of page numbers necessary for generation of a sentence according to the constraint information, output from the model, and a sequence of correct page numbers for the input in a case where the task type information input into the model indicates a task of determining a page number necessary for generation of a sentence.

3. The text generation training apparatus according to claim 1, wherein
the constraint information is a question sentence, and
the program instructions cause the processor to train a model, receiving, as input, information extracted from each of a plurality of document images, a question sentence related to generation of an answer sentence based on the information, and a page number of each of the plurality of document images, based on an estimation result of an output sequence related to the answer sentence from the model and a correct output sequence for the input.

4. The text generation training apparatus according to claim 1, wherein the model includes an encoder that generates a feature amount for the input, and a decoder that generates the estimation result based on the feature amount.

5. A text generation apparatus comprising:
a processor; and
a memory storing program instructions that cause the processor to
input second information extracted from each of a plurality of second document images, second constraint information related to generation of a sentence based on the second information, and a page number of each of the plurality of second document images into a trained model, and
generate an output sequence according to the plurality of second document images and the second constraint information based on output from the model, wherein
the model, receiving, as input, first information extracted from each of a plurality of first document images, first constraint information related to generation of a sentence based on the first information, and a page number of each of the plurality of first document images, has been trained based on an estimation result of an output sequence output from the model and a correct output sequence for the input.

6. A text generation training method performed by a computer, the text generation training method comprising:
training a model, receiving, as input, information included in each of a plurality of document images, constraint information related to generation of a sentence based on the information, and a page number of each of the plurality of document images, based on an estimation result of an output sequence output from the model and a correct output sequence for the input.

7. A non-transitory computer-readable recording medium having computer-readable instructions stored thereon, which when executed, cause a computer to execute the text generation training method of claim 6.
